(19) United States
(12) Patent Application Publication
(10) Pub. No.: US 2005/0231767 A1
(43) Pub. Date: Oct. 20, 2005

(54) Touch sensitive scan area selection apparatus and method

(76) Inventors: Gregory A. Brake, Fort Collins, CO (US); William Robert Haas, Fort Collins, CO (US); Kirk Steven Tecu, Greeley, CO (US); John M. Carleton, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/826,008

(22) Filed: Apr. 16, 2004

(51) Int. Cl. H04N 1/04

(52) U.S. Cl. 358/474

(57) ABSTRACT

A “see-through” scanner comprises a touch-sensitive panel that enables a scanner user to designate an area to be scanned by touching the scanner.

### FIELD OF THE INVENTION

The present invention relates generally to document and image scanners.

### BACKGROUND OF THE INVENTION

A typical desktop scanner is capable of scanning documents or photographs of a size typical of a printed page. A common scanner size allows a scanner user to scan original items up to about 8.5 by 11.7 inches, encompassing both the “letter” and A4 standard paper sizes. However, a scanner user often wishes to scan only a portion of a page, or wishes to scan a photograph or other item that is smaller than a standard paper size. Many modern scanning systems enable system users to specify what portion of the available scanning area is to be scanned. Often, the system performs a preview scan, displays a low-resolution image of the scanning area on a computer screen, and allows the user to designate an area to be captured in a “final” scan. A preview scan is often done at a relatively low resolution, and is often used for setting various scanning parameters such as exposure and color balance, and for scan area designation. The preview scan data is typically discarded once it has been analyzed and the scanning parameters have been determined. A final is a scan from which the data is to be used for printing, storage, incorporation into an electronic document, or for some other purpose, and is often performed using parameters determined from the preview scan data. While a final scan often follows a preview scan, a final scan may be performed without a preview scan.

The area designation is often accomplished with a computer mouse or other pointing device by outlining the desired area in the computer display of the preview scan. The preview scan may be initiated by selecting a function in software operating on the computer, or may be initiated by pressing a button on the scanner itself Some systems perform automated region classification and selection, based on analysis of the results of a preview scan, so that a user need only designate, often with a single mouse click, which of the suggested regions displayed on the computer screen represents the area to be captured in the final scan.

While these methods represent significant improvements over earlier methods that preceded them, they still require the user to interact with both the computer and the scanner. Furthermore, if the original item moves during the interval between the preview scan and the final scan, the user may have no indication that the movement happened and the resulting final scan may not encompass the original item of interest.

There is a need for improved scanning area designation.

### SUMMARY OF THE INVENTION

A “see-through” scanner comprises a touch-sensitive panel that enables a scanner user to designate an area to be scanned by touching the scanner.

### BRIEF DESCRIPTION OF THE DRAWINGS

FIG. 1 schematically shows a perspective view of a “see-through” scanner.

FIG. 2 shows the see-through scanner of FIG. 1 raised from its scanning position so that its front side is visible to the viewer

FIG. 3 shows a partially exploded perspective view of a see-through scanner in accordance with an example embodiment of the invention.

FIG. 4 shows the scanner of FIG. 3 in an example mode of use.

FIG. 5A depicts one example arrangement and interconnection of the components of a scanning system in accordance with an example embodiment of the invention, in block diagram form.

FIG. 5B depicts an alternate example arrangement and interconnection of the components of a scanning system in accordance with an example embodiment of the invention, in block diagram form.

FIG. 6 shows a computer monitor with an example scanning software user interface displayed on it, and its relationship to the scanner of FIG. 3 in an example mode of use.

FIG. 7 shows a partially exploded view of a see-through scanner in accordance with another example embodiment of the invention.

FIG. 8 shows the scanner of FIG. 7 in an example mode of use.

FIG. 9A shows an example arrangement of components of a scanning system comprising the scanner of FIG. 7.

FIG. 9B shows an alternate example arrangement of components of a scanning system comprising the scanner of FIG. 7.

### DETAILED DESCRIPTION

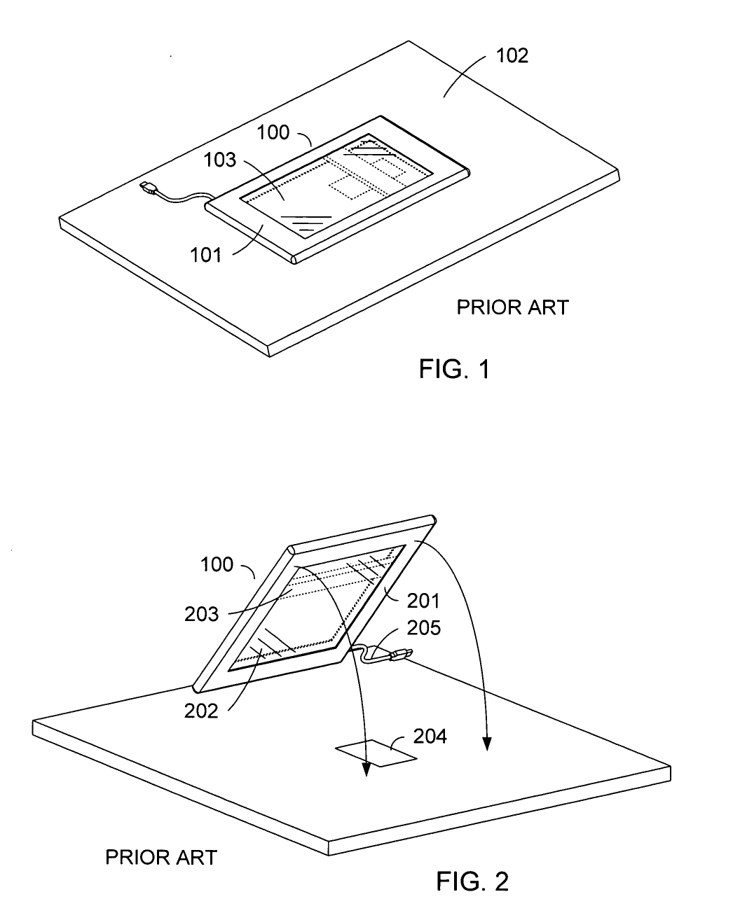

FIG. 1 schematically shows a perspective view of a “see-through” scanner 100. In FIG. 1, see-through scanner 100 is shown in a “face down” configuration, so that that back side 101 of the scanner is toward the viewer, and the scanner is in position to scan items that are under it, on a support surface 102. See-through scanner 100 has a substantially transparent window 103 on back side 101.

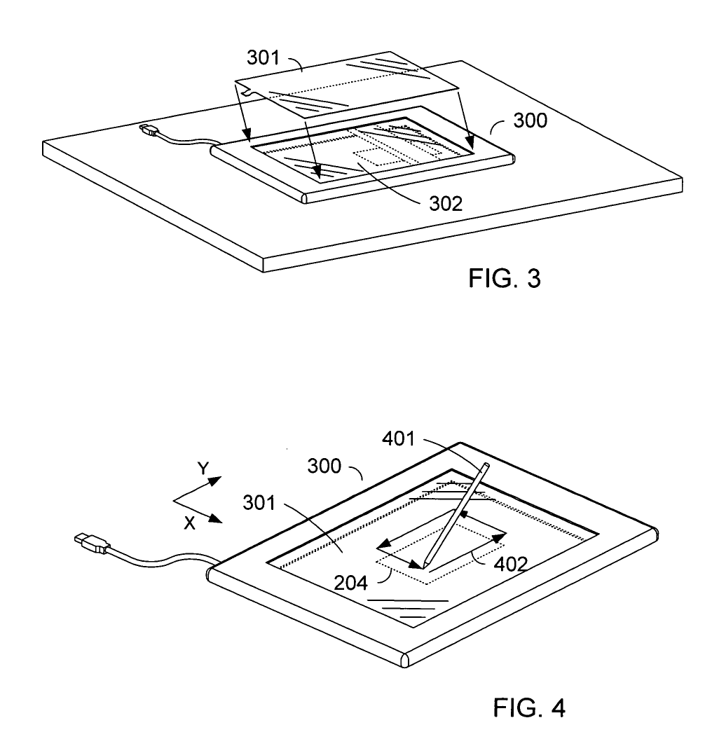

FIG. 2 shows see-through scanner 100 raised from its scanning position so that the front side 201 of the scanner is visible to the viewer. Front side 201 of see-through scanner 100 has a substantially transparent platen 202, through which an imaging assembly 203 can capture a digital image of an original item 204 when the original item 204 and the platen 202 are in relatively close proximity. The designations “front” and “back” are chosen arbitrarily, and may be interchanged.

Imaging assembly 203 provides illumination of the original item 204, and collects light reflected from original item 204. The reflected light is projected onto a sensor that has elements arranged generally linearly. Each sensor element accumulates an electrical charge in proportion to the intensity of light falling on it. These charges are quantified and converted to a numerical representation. Imaging assembly 203 is swept across original item 204 by a scanning mechanism (not shown), and the sensor elements are read periodically so that the collection of sensor readings forms an array of numbers representing the reflectance of the original item 204 as measured at a grid of locations. The array of numbers may be called a digital image. When properly interpreted, the digital image is an essentially photographic representation of original item 204. Often, scanner 100 transmits the digital image to a computer or other device for storage, display, modification, printing, or other uses. The transmission may be through an interface cable such as cable 205, or may be accomplished wirelessly, such as by radio frequency signals, infrared signals, or by other means.

FIG. 3 shows a partially exploded perspective view of a see-through scanner 300 in accordance with an example embodiment of the invention. See-through scanner 300 comprises a touchscreen 301 affixed proximate to substantially transparent window 302 on the back side of scanner 300. Touchscreen 301 is shown displaced from window 302 in FIG. 3 for ease of explanation. A touchscreen is generally a thin, substantially transparent device for communicating coordinate information to a computer or other device. Window 302 may preferably be made of polycarbonate, or another substantially rigid and transparent material.

Several technologies are available for making touchscreens. In the resistive type touchscreen, two thin, clear, electrically conductive layers are held a small distance apart by thin, clear spacers. A differential voltage is applied between the conductive layers through contacts at spaced-apart points on the layers, often the corners of a rectangular touchscreen. The assembly may be adhered to a substrate, often a glass or plastic substrate, and a relatively hard clear protective may be applied to the exposed surface. When a relatively concentrated force is applied to the assembly, such as by a finger, stylus, or other mechanism, the two conductive layers are forced into electrical contact, completing an electrical circuit between the differential voltage references. Electrical current can then flow from the spaced-apart voltage application points on one layer to the voltage application points on the other layer, through the point of contact between the layers formed when the force is applied. The total current flowing between the layers is made up of component currents flowing from each of the spaced-apart voltage application points, and the portion coming from each spaced-apart voltage application point is inversely related to the distance from that voltage application point to the contact point where the force was applied to the touchscreen. The location of the force application can therefore be calculated from measurements of the electrical currents flowing at each of the spaced-apart voltage application points.

In addition to the resistive type touchscreen, other types include the capacitive type and the surface acoustic wave type. A scanner in accordance with an embodiment of the invention may use any touchscreen technology. Touchscreen assemblies are available from commercial sources, such as Fujitsu Components America, Inc. of Sunnyvale, Calif., USA, the 3M Company of St. Paul, Minn., USA, and Synaptics, Inc. of San Jose, Calif., USA.

In a first example embodiment, a see-through scanner 300 comprising a touchscreen 301 may operate as shown in FIG. 4. In FIG. 4, scanner 300 has been placed face down over original item 204. A user of the scanner uses a pointing device such as stylus 401 or even a finger to trace perimeter 402 of an area to be captured in a scan. The multiple locations touched in the process of tracing perimeter 402 are sensed by touchscreen 301. The user may simply trace around a projection of the perimeter of original item 204, visible through the scanner, and the area to be scanned may be selected to include the area enclosed by perimeter 402, as projected through scanner 300 to a platen on the front side of scanner 300. The platen on the front side of scanner 300 is substantially transparent, and may preferably be made of glass, or another substantially rigid and transparent material.

For the purposes of this disclosure, a perimeter or other figure traced on the back side of a see-through scanner is taken to transfer by orthogonal projection to the front side of the scanner. In other words, tracing a perimeter on the back side of the scanner suffices to select, as an area to scan, the area of the platen enclosed by an orthogonal projection of the perimeter to the platen side of the scanner, even though the surface actually traced upon is displaced from the plane of the original item or the platen by approximately the thickness of the scanner.

Coordinate axes X and Y, shown in FIG. 4, provide a reference frame for describing touch locations. For example, a particular point at which touchscreen 301 is touched may be described by a coordinate pair (x,y), giving the location of the touch point in the two coordinate directions.

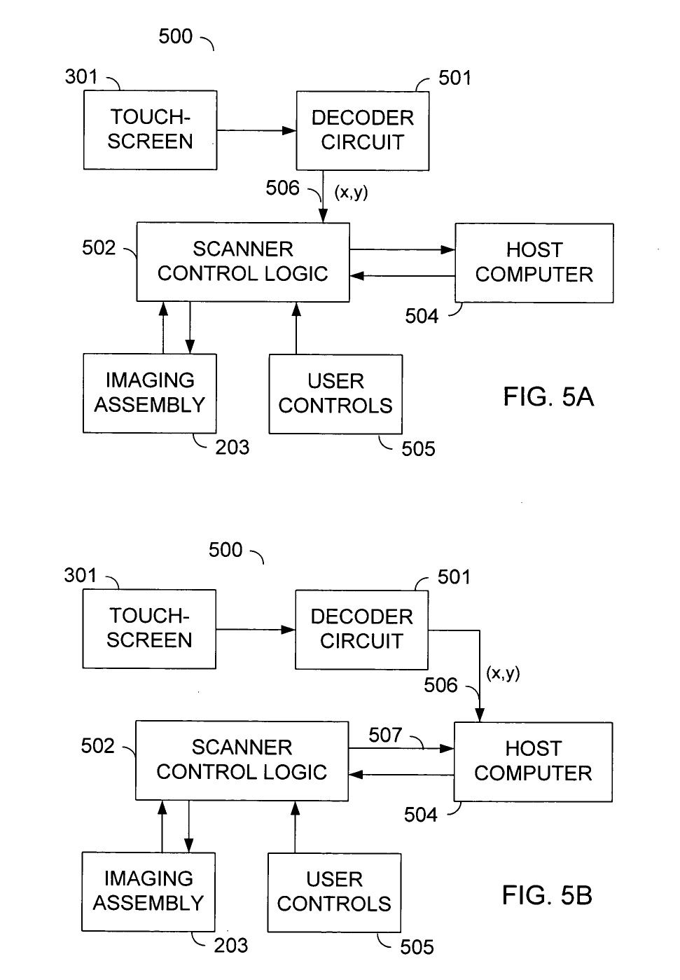

FIG. 5A depicts one example arrangement and interconnection of the components of a scanning system 500 in accordance with an example embodiment of the invention, in block diagram form. Touchscreen 301 sends signals to a decoder circuit 501, which translates the analog current measurements from touchscreen 301 into digital values 506 representing X and Y coordinates of locations where touchscreen 301 is touched. In this way, touch location information is generated indicating locations where touchscreen 301 is touched. Decoder circuit 501 may be a separate circuit, possibly placed near one edge of touchscreen 301, or may be comprised in scanner control logic 502. Scanner control logic 502 may include a microprocessor system, dedicated hardware, or both, and controls the motion and operation of an imaging assembly 503. Scanner control logic 502 may also communicate with a host computer 504, and may accept inputs from the scanner user through user controls 505. User controls 505, for example, may comprise buttons or other controls for communicating to the scanner when to start a scan, the intended use for the digital image, or other information. Scanner control logic 502 may also comprise memory for storage of a portion or all of a digital image resulting from a scan, and may perform other functions.

In one example mode of use, a scanner user may place scanner 300 face down on original item 204, trace perimeter 402 to indicate an area to be scanned, and press a user control button 505 to start the scan. Scanner control logic 502 may be enabled to interpret the signals from decoder circuit 501 and configure itself to scan only the desired area. Alternatively, scanner 300 may send the signals 506 from decoder circuit 501 to a host computer 504, which is configured to interpret the signals and then send configuration information back to scanner 300 for selecting an area to be scanned. The configuration information is derived from the touch location information carried in signals 506. This alternate example arrangement is shown in FIG. 5B. Signals 506 may pass through an interface that also carries other signals 507. The user may initiate the scan by pressing a user control 505. In this alternate arrangement, more of the process of scanner configuration is performed in the host computer, which may provide for more flexibility and may enable a simpler scanner design.

In this example mode of use, the scanner user interacts with the scanner throughout the entire process of setting up and initiating a scan. The user need not shift his or her attention from one device to another. The complexity of the process is reduced and the reliability of the process is improved as compared with other methods.

In designating an area to scan, the user need not trace a perfectly rectangular perimeter, and the perimeter need not be fully closed. The logic interpreting the touch location signals 506, be it scanner control logic 502 or host computer 504, may “rectangularize” the touch location information. For example, the logic may select for scanning a rectangular area that encompasses all of the sensed touch locations. Such a rectangular area can be selected by specifying a rectangle whose X-direction extent extends from the smallest to the largest of the X coordinates of all the sensed touch locations, and whose Y-direction extent extends from the smallest to the largest of the Y coordinates of all the sensed touch locations. Using this selection technique, a perimeter or other figure drawn imperfectly will suffice to select a scan area that encompasses original item 204 so long as the drawn perimeter extends beyond the perimeter of original item 204 at one location or more on each perimeter side. Similarly, the user could select a scanning area that encompasses original item 204 by simply making a diagonal stroke across touchscreen 301, from a point near one corner of original item 204 to the opposite corner. The user could similarly select an entire page for scanning by tracing a single stroke from one corner of window 302 to the opposite corner.

The logic interpreting the touch location signals 506 may attempt to reduce the probability of responding to extraneous touches of touchscreen 301. For example, the logic may restrict its consideration to touches that occur in a fixed time interval. For example, the logic may, in selecting a scan area, consider only touches that occur in the 10 seconds immediately prior to the initiation of a scan. Alternatively, the user may perform a reset, or clearing operation by pressing a user control 505, and the logic interpreting the touch location signals 506 may consider only touches that occur after the reset or clearing operation.

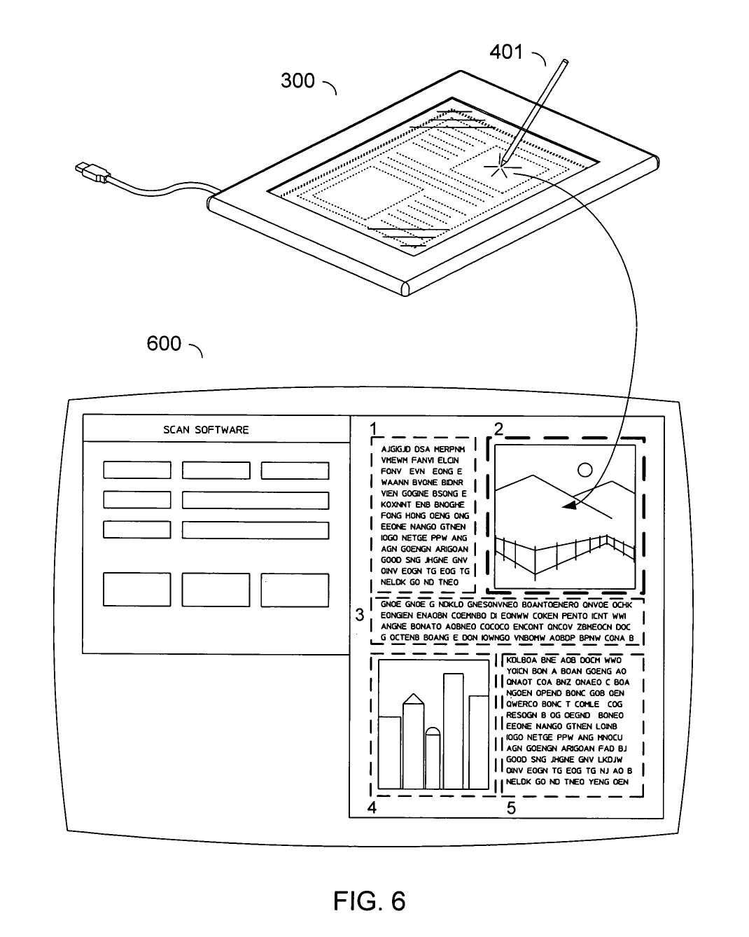

In another example mode of use, scanner 300 interacts with automated region detection software executing on host computer 504. In this mode of use, a scanner user initiates a preview scan, either by actuating a scanner user control 505 or through a software user interface on computer 504. A preview digital image is transmitted to computer 504 and displayed as shown in FIG. 6. FIG. 6 shows a computer monitor 600 with an example scanning software user interface displayed on it, and its relationship to scanner 300 in this example mode of use. In the example display of FIG. 6, the original item that has been the subject of the preview scan may be a magazine or book page containing regions of text and photographs. The automated region detection software has analyzed the preview digital image and identified five regions that are likely to be the subject of desired scans, and has presented the user with a depiction of them. The user of the system may select one of the regions by simply touching scanner 300 over that region of the page, for example with an object such as stylus 401 or with a finger. For example, if the user is interested in a final scan of only the photograph in region 2, the user can simply touch scanner 300 on touchscreen 301 over that photograph, as is shown in FIG. 6. The location of the touch is noted, and only that area is scanned for later use. For example, the location of the touch may be transmitted to computer 504, and computer 504 may send configuration commands to scanner 300 to accomplish the scan area designation. The final scan may be started automatically upon receipt of the scan area designation. Alternatively, the scanner itself may, using internal logic, perform the automated region detection, and configure itself to perform a final scan encompassing only the region that encompasses the touch location. In this configuration, the scanner need not transmit the preview digital image to a computer for processing.

Automated region classification and selection software is known in the art. Several methods are described in Pavlidis, et al., “Page Segmentation and Classification,” CVGIP: Graphical Models and Image Processing, vol. 54, No. 6, November 1992, pp. 226-238.

In yet another example mode of use, the scanner user may start a scan by simply touching scanner 300 on touchscreen 301 over the portion of original item that the user desires to scan. Scanner 300 then initiates a preview scan, transmits the preview digital image and the touch location to host computer 504, which performs automated region detection. Once computer 504 has identified the regions of the original item that are likely to be desired final scan areas, it determines which region encompasses the touch location, and sends configuration information to scanner 300 such that scanner 300 is configured to perform a final scan that encompasses only that region. The final scan may be initiated upon receipt of the configuration information. Alternatively, the scanner itself may, using internal logic, perform the automated region detection, and configure itself to perform a final scan encompassing only the region that encompasses the touch location. In this configuration, the scanner need not transmit the preview digital image to a computer for processing.

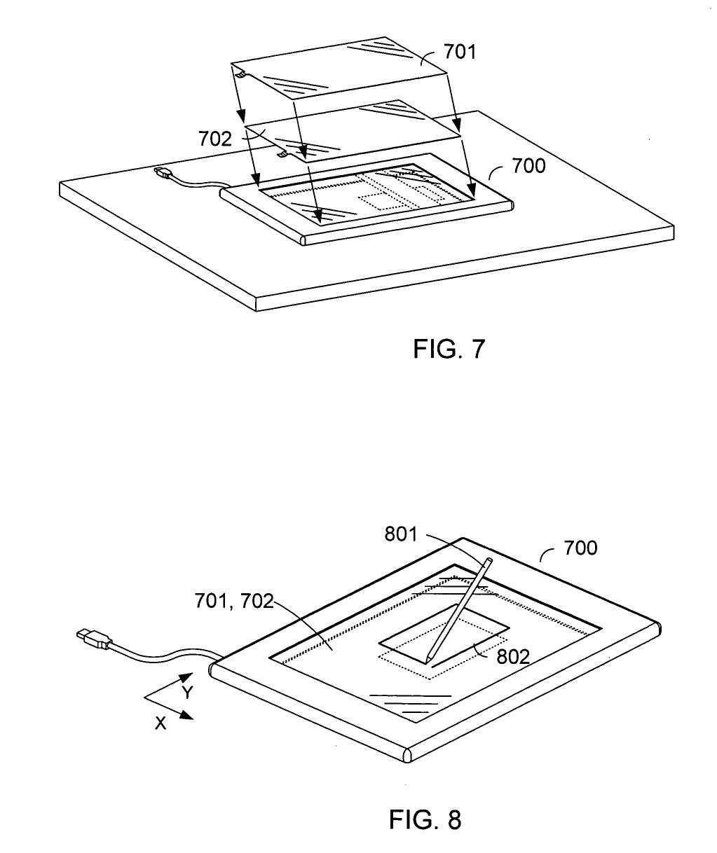

FIG. 7 shows a partially exploded view of a see-through scanner 700 in accordance with another example embodiment of the invention. In this example embodiment, see-through scanner 700 comprises a touchscreen 701 and a liquid crystal panel 702 affixed proximate to a substantially transparent window 703 on the back side of see-through scanner 700. Liquid crystal panels are known in the art, and typically comprise two light-polarizing sheets with an array of individually-addressable liquid crystal elements sandwiched between the light-polarizing sheets. The light-polarizing sheets are oriented so that their polarization directions are substantially perpendicular. The liquid crystal elements have the property that the polarization of light passing through each element is responsive to an electrical voltage across the element. When an element is supplied with a voltage such that the polarization of light passing through the element is rotated about 90 degrees, light entering one of the polarizing sheets at that element can pass through the second polarizing sheet as well because its polarization has been modified by the liquid crystal in between. When an element is supplied with a voltage that leaves the polarization of light passing through the element essentially unchanged, light entering one of the polarizing sheets at that element is blocked when it encounters the second polarizing sheet. The element voltages are typically applied through electrical conductors made of a transparent material, so that the panel is substantially transparent when the elements are in their light-transmitting state.

Each liquid crystal element thus forms a small light shutter. When an element is configured to block light passing through it, objects behind that element will not be visible through it. When an element is configured to pass light through it, objects behind the element will be visible. A liquid crystal panel is a component of the familiar and widely-available liquid crystal display (LCD) used, for example, in many portable computers.

Example scanner 700 uses the light shuttering function of liquid crystal panel 702 in conjunction with touchscreen 701 to provide an image area selection method with user feedback. One example mode of use is depicted in FIG. 8. In this example mode of use, the user selects a scan area by tracing around the portion of an original item that the user desires to scan. The original item is visible through the scanner because both the top and bottom of the scanner are generally transparent. The tracing may be done with an object such as stylus 801, or simply with the user's finger. Touchscreen 701 detects and reads the locations of the touches, and elements of liquid crystal panel 702 that are closest to the touch locations are switched to their light-blocking state, so the path traversed by the user's touch is marked by a darkened border 802 in liquid crystal panel 702. Darkened border 802 gives the user convenient feedback about the scan area that has been selected.

Other methods of providing user feedback are possible. For example, if the touch location information obtained using touchscreen 701 has been rectangularized in order to select an area to scan, the rectangularized area may be outlined in liquid crystal panel 702 by switching the appropriate elements to their light-blocking state.

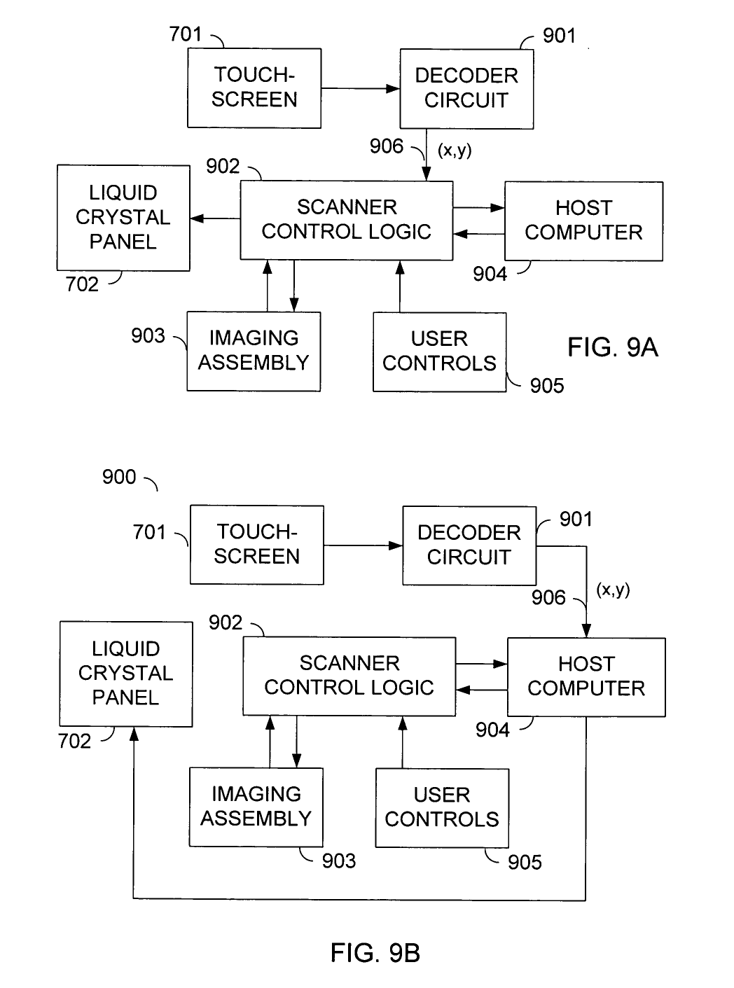

FIG. 9A shows an example arrangement of components of a scanning system 900 comprising see-through scanner 700. Touchscreen 701 detects touches of the top surface of scanner 700. Decoder circuit 901 computes X and Y locations of the touches, and passes this information 906 to scanner control logic 902. Scanner control logic 902 causes liquid crystal panel 702 to darken the liquid crystal elements in the same X and Y locations as the detected touches. Scanner control logic 902 also controls the operation of imaging assembly 903, accepts input from user controls 905 and may communicate with a host computer 904.

In an alternative arrangement, shown in FIG. 9B, decoder circuit 901 supplies its touch location information 906 to host computer 904, and host computer 904 also controls liquid crystal panel 702. This arrangement may simplify the integration of the scan area selection system into the design of a scanner.

Once a scan area has been selected, a scan of that area may be initiated automatically upon closure of the area boundary drawn by the user on touchscreen 701, may be initiated when the user actuates a user control 905 on scanner 700, or may be initiated by indicating to scanning software running on host computer 904 that a scan is to be started. Darkened border 802 may be automatically cleared by returning all of the liquid crystal elements in liquid crystal panel 702 to their light-transmitting states at the end of a scan, or a user control on scanner 700 may enable clearing of the liquid crystal panel by the user.

1. A scanner, comprising a touchscreen affixed to one outer surface of the scanner, and wherein touch location information is generated indicating where the touchscreen is touched, and wherein the touch location information is used to select an area to scan.

2. A scanner, comprising:
a substantially transparent platen on a first side of the scanner;
a substantially transparent window on a second side of the scanner, opposite the first side; and
a touchscreen affixed proximate to the substantially transparent window;
and wherein touch location information is generated in response to at least one touch of the touchscreen, and wherein the touch location information is used to select an area to scan.

3. The scanner of claim 2, wherein the area to scan is selected to encompass a figure traced on the touchscreen by a user of the scanner.

4. The scanner of claim 2, wherein the area to scan is rectangularized.

5. The scanner of claim 2, wherein only touches occurring during a pre-determined interval are considered in the selection of the area to scan.

6. The scanner of claim 5, wherein the pre-determined interval immediately precedes initiation of a scan.

7. The scanner of claim 5, wherein the pre-determined interval is the ten seconds immediately preceding initiation of a scan.

8. The scanner of claim 2, wherein only touches occurring after a reset operation are considered in the selection of the area to scan.

9. The scanner of claim 2, further comprising scanner control logic, and wherein the scanner control logic interprets the touch location information and selects the area to scan.

10. The scanner of claim 2, wherein the scanner performs the following method:
performing a preview scan that results in a preview digital image;
analyzing the preview digital image using automated region detection; and
selecting as the area to scan an automatically-detected region that encompasses a location of a touch of the touchscreen.

11. The scanner of claim 10, wherein performing the preview scan occurs before the touch of the touchscreen.

12. The scanner of claim 10, wherein performing the preview scan occurs after the touch of the touchscreen.

13. The scanner of claim 2, further comprising a liquid crystal panel interposed between the touchscreen and the substantially transparent window, and wherein the liquid crystal panel is used to provide user feedback about the selected area to scan.

14. The scanner of claim 13, wherein user feedback is provided by switching at least one liquid crystal element in the liquid crystal panel to a light-blocking state in response to at least one touch of the touchscreen.

15. The scanner of claim 14 wherein liquid crystal elements nearest to locations where the touchscreen is touched are switched to the light-blocking state.

16. The scanner of claim 14, wherein the liquid crystal elements switched to the light-blocking state outline a perimeter of the area to scan.

17. The scanner of claim 16, wherein the perimeter is rectangularized.

18. A system, comprising:
a) a scanner, comprising
a substantially transparent platen on a first side of the scanner;
a substantially transparent window on a second side of the scanner, opposite the first side; and
a touchscreen affixed proximate to the substantially transparent window; and
b) a computer;
and wherein the computer and the scanner are in communication, and wherein touch location information is generated in response to at least one touch of the touchscreen, and wherein the touch location information is used by the system to select an area to scan near the platen.

19. The system of claim 18 wherein the computer and scanner communicate through a cable.

20. The system of claim 18 wherein the computer and scanner communicate wirelessly.

21. The system of claim 18, wherein the touch location information is sent to the computer, and the computer sends to the scanner configuration information derived from the touch location information, the configuration information indicating the area to scan.

22. The system of claim 18, wherein the area to scan is selected to encompass a figure traced on the touchscreen by a user of the system.

23. The system of claim 18, wherein the area to scan is rectangularized.

24. The system of claim 18, wherein only touches occurring during a pre-determined interval are considered in the selection of the area to scan.

25. The system of claim 24, wherein the pre-determined interval immediately precedes initiation of a scan.

26. The system of claim 24, wherein the pre-determined interval is the ten seconds immediately preceding initiation of a scan.

27. The system of claim 18, wherein the system performs the following method:
performing a preview scan that results in a preview digital image;
transmitting the preview digital image to the computer;
analyzing the preview digital image in the computer using automated region detection software; and
sending configuration information from the computer to the scanner specifying an area to scan, the area to scan encompassing an automatically detected region that encompasses the location of a touch of the touchscreen.

28. The system of claim 27, wherein performing the preview scan occurs before the touch of the touchscreen.

29. The system of claim 27, wherein performing the preview scan occurs after the touch of the touchscreen.

30. The system of claim 18, further comprising a liquid crystal panel interposed between the touchscreen and the substantially transparent window, and wherein the liquid crystal panel is used to provide feedback to a user of the system about the area to scan.

31. The system of claim 30, wherein user feedback is provided by switching at least one liquid crystal element in the liquid crystal panel to a light-blocking state in response to at least one touch of the touchscreen.

32. The system of claim 31, wherein liquid crystal elements nearest to locations where the touchscreen is touched are switched to the light-blocking state.

33. The system of claim 31, wherein the liquid crystal elements switched to the light-blocking state outline a perimeter of the area to scan.

34. The system of claim 33, wherein the perimeter is rectangularized.

35. A method, comprising:
detecting at least one touch of a touchscreen affixed proximate to a substantially transparent window on a first side of a scanner; and
selecting, based on the location of the at least one touch, an area to scan near a substantially transparent platen on a second side of the scanner, opposite the first side.

36. The method of claim 35, wherein:
detecting at least one touch of the touchscreen further comprises detecting the tracing of a figure on the touchscreen;
and wherein selecting an area to scan further comprises rectangularizing the area to scan to fully encompass the figure.

37. The method of claim 35, wherein only touches occurring during a pre-selected interval before an initiation of a scan are considered.

38. The method of claim 37, wherein the pre-selected interval is a 10-second interval immediately preceding the initiation of the scan.

39. The method of claim 35, further comprising performing a reset operation, and wherein only touches occurring after the reset operation are considered.

40. The method of claim 35, performed entirely in the scanner.

41. The method of claim 35, wherein part of the method is performed in the scanner and part of the method is performed in a computer that is in communication with the scanner.

42. The method of claim 35, further comprising:
performing a preview scan that results in a preview digital image;
analyzing the preview digital image using automated region detection; and
selecting, as the area to scan, an automatically detected region encompassing a location where the touchscreen was touched.

43. The method of claim 42, wherein performing the preview scan occurs after the touch of the touchscreen.

44. The method of claim 42, wherein performing the preview scan occurs before the touch of the touchscreen.

45. The method of claim 42, wherein the step of analyzing the preview digital image is performed in a computer that is in communication with the scanner.

46. The method of claim 35, further comprising providing feedback about the selected area to scan using a liquid crystal panel interposed between the touchscreen and the substantially transparent window.

47. The method of claim 46, wherein providing feedback about the selected area to scan further comprises switching at least one element of the liquid crystal panel to a light-blocking state.

48. The method of claim 47, wherein the elements nearest the locations of touches of the touchscreen are switched to the light-blocking state.

49. The method of claim 47, wherein the elements switched to the light-blocking state outline a perimeter of the selected area to scan.

50. The method of claim 49 wherein the perimeter is rectangularized.

51. A scanner, comprising:
means for detecting locations of touches of a touchscreen affixed to one side of the scanner; and
means for selecting, based on the touch locations, an area to scan.
